(19) United States
(12) Patent Application Publication
(10) Pub. No.: US 2021/0048853 A1
(43) Pub. Date: Feb. 18, 2021

(54) HINGE ASSEMBLIES WITH SEALED GEAR UNITS

(71) Applicant: Hewlett-Packard Development Company, L.P., Spring, TX (US)

(72) Inventors: WEI-CHUNG CHEN, Taipei (TW); Chi-Hao Chang, Taipei (TW); Kuan-Ting WU, Taipei (TW)

(21) Appl. No.: 16/965,567

(22) PCT Filed: Jan. 29, 2018
(86) PCT No.: PCT/US2018/015632

§ 371 Date: Jul. 28, 2020

(51) Int. Cl. G06F 1/16; E05D 3/12

(52) U.S. Cl. CPC G06F 1/1681; E05D 3/122; E05Y 2800/12; E05Y 2800/43; E05Y 2201/696; E05Y 2900/606

(57) ABSTRACT

In one example, a hinge assembly is disclosed, which may include a first bracket, a second bracket, and at least one shaft to pivotally connect the first bracket and the second bracket. Further, the hinge assembly may include a gear unit coupled to the at least one shaft. Furthermore, the hinge assembly may include a sealant disposed around the gear unit to hold a viscous fluid.

### BACKGROUND

Electronic devices such as laptop computers, tablet computers, convertible devices, mobile phones, and the like may include a first housing, a second housing, and a hinge assembly mounted between the first housing and the second housing. For example, the first housing may house a keyboard, a motherboard, and/or other components. The second housing may house a display. The hinge assembly may be pivotally connected to the first housing and the second housing along at least one axis.

### BRIEF DESCRIPTION OF THE DRAWINGS

Examples are described in the following detailed description and in reference to the drawings, in which:

FIG. 1 is a cross-sectional view of an example hinge assembly;

FIG. 2 is a cross-sectional view of another example hinge assembly for an electronic device;

FIG. 3 is a cross-sectional view of the example hinge assembly of FIG. 2, depicting additional features;

FIG. 4 is an exploded view of the example hinge assembly of FIG. 2, depicting additional features; and

FIG. 5 is a perspective view of a portion of an example electronic device including the example hinge assembly as shown in FIGS. 2, 3, and 4.

### DETAILED DESCRIPTION

Hinged electronic devices, such as laptop computers, tablet computers, personal digital assistants (PDAs), and flip mobile phones, may include a base housing and a display housing connected by a hinge. The display housing may include a display (e.g., a touchscreen) and the base housing may include input devices, such as a keyboard, a pointing stick, mouse buttons, a touchpad, and/or a trackpad. The display housing may be attached to the base housing such that the display housing can be moved and/or rotated with respect to the base housing along at least one axis to hold the display at multiple positions. To achieve such rotation, the display housing can be attached to the base housing using at least one hinge that allows the display housing to be rotated about the base housing. The hinge can be of a double-axis construction wherein two shafts are separately attached to the device parts and a coupling is engaged with the two shafts to allow the shafts to be used as two pivot axes.

For example, the hinges may include a pair of brackets and shafts to pivotally connect the pair of brackets. The shafts may be coupled to a gear unit. The gear unit may enable rotation of the display housing with respect to the base housing. During rotation of the display housing, the display housing may be held at multiple angular positions by the resistance force generated between the gears of the gear unit and the shafts. However, such electronic devices may have the issue of gear backlash which can affect smooth rotation of gears.

The term “gear backlash” may refer to a problem in bi-directional transmission systems in which, on reversal of the drive, the driven gear, which now becomes the driving gear, may rotate, albeit by a small amount equivalent to the backlash, before drive in the reverse direction can be established. The movement of the driven gear (i.e., now the driving gear) prior to establishment of transmission drive may be referred to as the gear backlash. Gear backlash may not be desirable as the gear backlash can create transmission shocks which can result in damage of the gear teeth. Electronic devices that use gear mechanisms for enabling bi-directional rotation (e.g., during opening and closing of the display housing) may have the issue of gear backlash which may affect smooth rotation of the housings with respect to each other. The gear backlash may also result in wear and tear of moving parts of the electronic device.

Examples described herein may reduce the gear backlash in hinge assemblies. Examples described herein may seal the gear unit with a sealant that holds a viscous fluid, such as damping grease, to provide a resistance force on the gears of the gear unit. Further, examples described herein may enhance reliability as the damping grease can share a part of torque consumption.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described may be included in at least that one example, but not necessarily in other examples.

Examples described herein may provide a hinge assembly for an electronic device, which may include a first bracket, a second bracket, and at least one shaft to pivotally connect the first bracket and the second bracket. Further, the hinge assembly may include a gear unit coupled to the at least one shaft. Furthermore, the gear unit may be sealed with a sealant that holds a viscous fluid, such as damping grease.

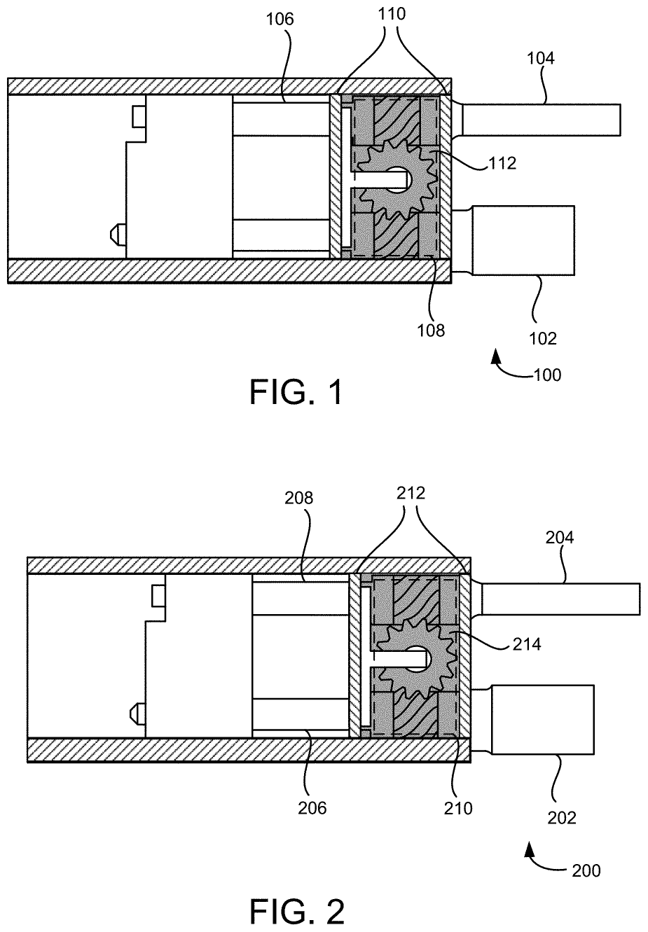

Referring now to figures, FIG. 1 is a cross-sectional view of an example hinge assembly 100. Example hinge assembly 100 may be a single-axis hinge assembly or a dual-axis hinge assembly. Hinge assembly 100 may pivotally connect a first housing to a second housing along at least one axis. Hinge assembly 100 may include a first bracket 102, a second bracket 104, and at least one shaft 106 to pivotally connect first bracket 102 and second bracket 104. Further, hinge assembly 100 may include a gear unit 108, a sealant 110 disposed around gear unit 108, and a viscous fluid 112 filled within sealant 110.

In one example, first bracket 102 may engage with a first housing of an electronic device and second bracket 104 may engage with a second housing of the electronic device. Example first housing may be a base housing and example second housing may be a display housing. For example, in the single-axis hinge assembly, gear unit 108 coupled to shaft 106 may provide a resistance force between the first housing and the second housing.

In one example, sealant 110 may include a pair of side walls with each side wall defining at least one opening to receive shaft 106. For example, sealant 110 disposed around gear unit 108 may be made up of an elastic material (e.g., a rubber material). Sealant 110 may ensure that viscous fluid 112 does not leak out of gear unit 108. Example viscous fluid 112 may be a damping grease. Examples described herein can also be implemented in a dual-axis hinge assembly for an electronic device, as shown in FIG. 2.

FIG. 2 is a cross-sectional view of an example hinge assembly 200 for an electronic device. Example hinge assembly 200 may be a dual-axis hinge assembly. Hinge assembly 200 may pivotally connect a first housing to a second housing of the electronic device along two axes. Example hinge assembly 200 may include a first bracket 202, a second bracket 204, a first shaft 206 coupled to first bracket 202, and a second shaft 208 coupled to second bracket 204. Second bracket 204 can be pivotally connected to first bracket 202 via first shaft 206 and second shaft 208. Further, hinge assembly 200 may include a gear unit 210 coupled between first shaft 206 and second shaft 208 to enable synchronous rotation between first shaft 206 and second shaft 208. Furthermore, hinge assembly 200 may include a sealant 212 to seal gear unit 210. Also, hinge assembly 200 may include a viscous fluid 214 disposed within sealant 212. In one example, first bracket 202 may engage with the first housing and second bracket 204 may engage with the second housing. Example first housing may be a base housing and example second housing may be a display housing or vice versa.

In one example, hinge assembly 200 may enable first shaft 206 and second shaft 208 to rotate in a synchronous manner in reverse directions upon rotating the first housing with respect to the second housing (e.g., while opening and closing of the first housing relative to the second housing). Hinge assembly 200 may allow the first housing to rotate through about 360 degrees with respect to the second housing or vice versa.

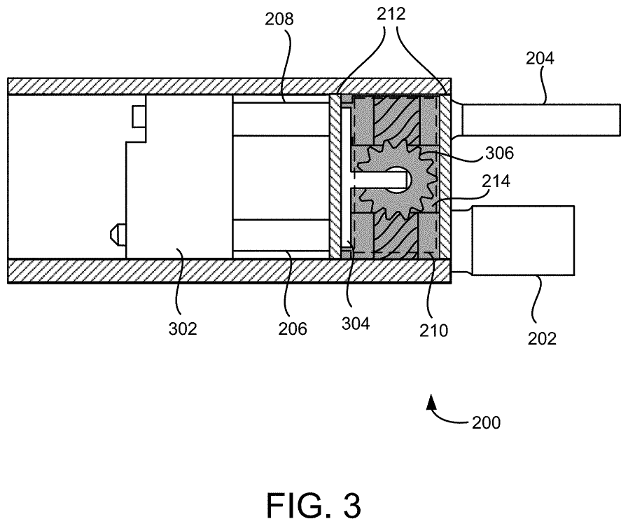

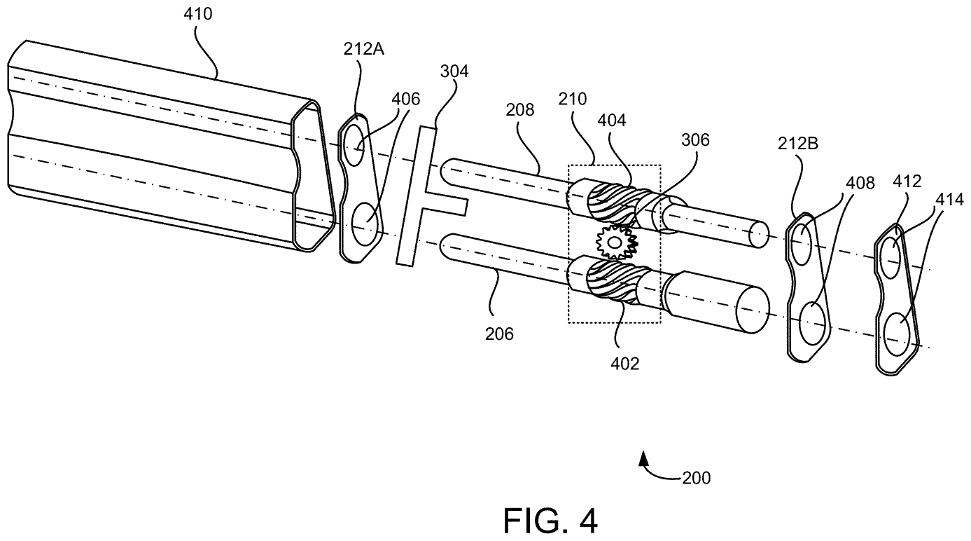

FIG. 3 is a cross-sectional view of example hinge assembly 200 of the hinge assembly of FIG. 2, depicting additional features. For example, similarly named elements of FIG. 3 may be similar in structure and/or function to elements described with respect to FIG. 2. Example hinge assembly 200 may include a torque engine 302 engaged with first shaft 206 and second shaft 208 to provide a frictional force between first bracket 202 and second bracket 204. The frictional force may allow the first housing to be held at multiple angular positions relative to the second housing. As shown in FIG. 3, gear unit 210 may include at least one gear wheel 306 disposed between first shaft 206 and second shaft 208. Further, gear unit 210 may include at least one idle gear holder 304 to hold at least one gear wheel 306. An example gear mechanism is shown in FIG. 4.

FIG. 4 is an exploded view of example hinge assembly 200 of FIGS. 2 and 3, depicting additional features. For example, similarly named elements of FIG. 4 may be similar in structure and/or function to elements described with respect to FIGS. 2 and 3. As shown in FIG. 4, gear unit 210 may include a first guide threaded portion 402 on first shaft 206, a second guide threaded portion 404 on second shaft 208, and gear wheel 306 to engage with first guide threaded portion 402 and second guide threaded portion 404 to enable synchronous rotation between first shaft 206 and second shaft 208 in reverse directions. Further, idle gear holder 304 may hold gear wheel 306 such that gear wheel 306 is physically engaged with first guide threaded portion 402 and second guide threaded portion 404.

In one example, viscous fluid (e.g., viscous fluid 214 of FIG. 3) disposed within sealant may fill the gaps between gear wheel 306, first guide threaded portion 402 and second guide threaded portion 404. When the user of the electronic device opens or closes the electronic device, gear wheel 306 may physically engage with first and second guide threaded portions 402 and 404 to transmit torque between first shaft 206 and second shaft 208 thereby allowing synchronous rotation between first and second shafts 206 and 208 in reverse directions.

In one example, while opening the electronic device, first guide threaded portion 402 may act as a driving gear and gear wheel 306 may act as a driven gear. On changing directions (e.g., during closing of the electronic device), a reversal of drive happens, and the driven gear, which now becomes the driving gear, may rotate, albeit by a small amount equivalent to the backlash, before drive in the reverse direction may be established. In this example, viscous fluid 214 may fill the gap between gear wheel 306 and first and second threaded portions 402 and 404 to reduce gear backlash. By filling the gaps between the gear teeth upon reversal of drive, viscous fluid may reduce the gear backlash and also potential wear and tear to components of gear unit 210.

Further, sealant (e.g., sealant 212 as shown in FIGS. 2 and 3) may include a pair of side walls 212A and 2128. Furthermore, side wall 212A may include a pair of openings 406 and side wall 2128 may include a pair of openings 408. In one example, openings 406 and 408 on side walls 212A and 212B may receive a corresponding one of first shaft 206 and second shaft 208. For example, side walls 212A and 212B may be made up of an elastic material (e.g., a rubber material) that does not allow viscous fluid (e.g., damping grease) from leaking out of gear unit 210. Once first and second shafts 206 and 208 pass through openings 406 and 408, sealant can securely hold the viscous fluid within gear unit 210 without any gap between shafts 206 and 208 and respective openings 406 and 408.

Furthermore, hinge assembly 200 may include a casing 410. Casing 410 may have at least one side wall 412 defining a pair of slots 414. In one example, pair of slots 414 may be aligned with corresponding openings 406 and 408 of side walls 212A and 212B. Pair of slots 414 may be aligned with openings 406 and 408 such that first and second shafts 206 and 208 are received through respective one of openings 406 and 408 and slots 414, and engaged with the first housing and the second housing of the electronic device.

In one example, casing 410 may be formed using a single-piece structure. In another example, casing may be formed by a hinge cap (e.g., 410) and a pair of hinge brackets (e.g., 412) connected to the hinge cap at both sides such that slots 414 may be defined in at least one of the hinge brackets (e.g., 412). Example casing 410 may be made up of a metallic substance, plastic material, fiber based material, polymer material, and the like.

In one example, sealant (e.g., sealant 212 as shown in FIGS. 2 and 3) may be formed using a single-piece structure defining an enclosed area around gear unit 210. In another example, sealant 212 may be formed by a hinge cap (e.g., 410) and a pair of side walls 212A and 212B defined in the hinge cap at both sides of gear unit 210 such that the viscous fluid may be held within an enclosed area formed by hinge cap (e.g., 410) and side walls 212A and 212B. In other examples, sealant 212 may include any other structure such that the viscous fluid can be held within sealant 212.

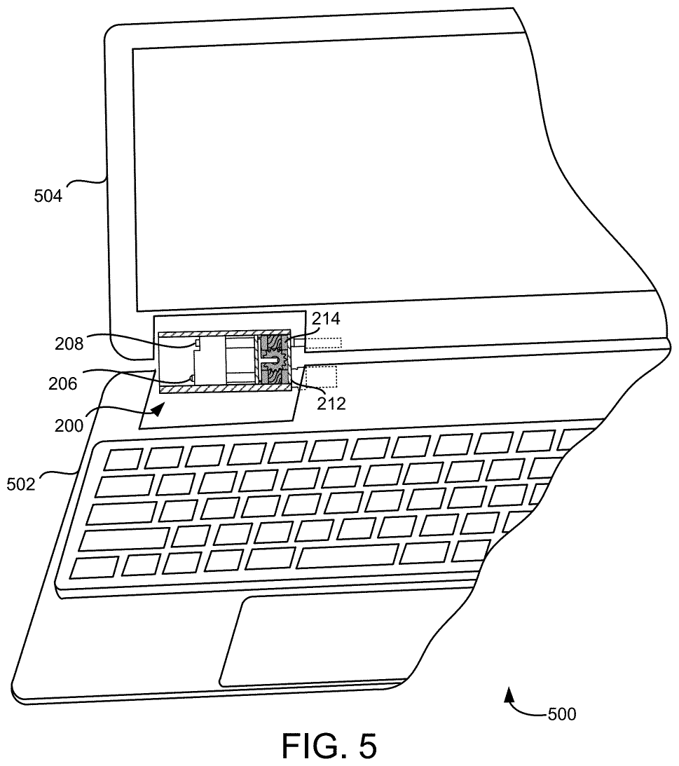

FIG. 5 is a perspective view of a portion of an example electronic device 500 including an example hinge assembly 200 with sealed gear unit. Electronic device 500 may include a first housing 502 and a second housing 504 pivotally connected to first housing 502 via hinge assembly 200. Example electronic device 500 may be a computing system, for example, a laptop, a convertible device, a PDA, a notebook, a sub-notebook, a personal gaming device, or other computing device with second housing 504 closeable onto first housing 502. Example convertible device may refer to a device that can be “converted” from a laptop mode to a tablet mode. In the tablet mode, second housing 504 may be closed with a display facing up and viewable, i.e., second housing 504 may be substantially parallel to and adjacent to first housing 502.

For example, first housing 502 may house a keyboard, a battery, a touchpad, and so on. Second housing 504 may house a display (e.g., a touchscreen display). Example display may include liquid crystal display (LCD), light emitting diode (LED), electro-luminescent (EL) display, or the like. Electronic device 500 may be equipped with other components such as a camera, audio/video devices, and the like, depending on the functions of electronic device 500. Hinge assembly 200 may be pivotally connected to first housing 502 and second housing 504. Hinge assembly 200 may allow second housing 504 to rotate in directions about the pivot axis relative to first housing 502.

Example hinge assembly 200 may include first shaft 206 coupled to first housing 502, second shaft 208 coupled to second housing 504, a gear unit (e.g., 210 as shown in FIGS. 2-4) coupled between first and second shafts 206 and 208, a sealant 212 disposed around gear unit, and a viscous fluid 214 disposed within sealant 212. Further, hinge assembly 200 may include at least one torque engine connected to shafts 206 and 208 to provide friction resistance between first housing 502 and second housing 504 during pivoting motion. For example, similarly named elements of FIG. 5 may be similar in structure and/or function to elements described with respect to FIGS. 2-4. Example components of hinge assembly 200 are explained in detail in FIGS. 2-4.

Examples described herein can also be implemented in hinge assemblies of non-electronic devices/apparatus such as suitcases, foldable chairs, foldable tables, hinged doors, and the like, which includes a gear mechanism for enabling bi-directional rotation. It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A hinge assembly comprising:
a first bracket;
a second bracket;
at least one shaft to pivotally connect the first bracket and the second bracket;
a gear unit coupled to the at least one shaft; and
a sealant disposed around the gear unit to hold a viscous fluid.

2. The hinge assembly of claim 1, wherein the sealant comprises a pair of side walls, each side wall defining at least one opening to receive the at least one shaft.

3. The hinge assembly of claim 1, wherein the sealant is made up of a rubber material.

4. The hinge assembly of claim 1, wherein the viscous fluid comprises a damping grease.

5. A dual-axis hinge assembly for an electronic device, comprising:
a first bracket;
a second bracket;
a first shaft coupled to the first bracket;
a second shaft coupled to the second bracket, wherein the second bracket is pivotally connected to the first bracket via the first shaft and the second shaft;
a gear unit coupled between the first shaft and the second shaft to enable synchronous rotation between the first shaft and the second shaft;
a sealant to seal the gear unit; and
a viscous fluid provided within the sealant.

6. The dual-axis hinge assembly of claim 5, further comprising:
a torque engine engaged with the first shaft and the second shaft to provide a frictional force between the first bracket and the second bracket.

7. The dual-axis hinge assembly of claim 5, wherein the gear unit comprises:
a first guide threaded portion on the first shaft;
a second guide threaded portion on the second shaft; and
at least one gear wheel to engage with the first guide threaded portion and the second guide threaded portion to enable the synchronous rotation between the first shaft and the second shaft in reverse directions.

8. The dual-axis hinge assembly of claim 7, wherein the gear unit comprises at least one idle gear holder to hold the at least one gear wheel such that the at least one gear wheel is to physically engage with the first guide threaded portion and the second guide threaded portion.

9. The dual-axis hinge assembly of claim 7, wherein the viscous fluid is to fill a gap between the at least one gear wheel and the first and second guide threaded portions.

10. The dual-axis hinge assembly of claim 5, wherein the sealant is made up of a rubber material, and wherein the viscous fluid comprises of a damping grease.

11. The dual-axis hinge assembly of claim 5, wherein the sealant comprises:
a pair of side walls; and
a pair of openings defined in each of the pair of side walls, wherein the pair of openings on each side wall are to receive a corresponding one of the first shaft and the second shaft.

12. An electronic device comprising:
a first housing;
a second housing; and
a dual-axis hinge assembly to pivotally connect the first housing and the second housing, wherein the dual-axis hinge assembly comprises:
a first shaft coupled to the first housing;
a second shaft coupled to the second housing;
a gear unit coupled between the first shaft and the second shaft;
a sealant disposed around the gear unit; and
a viscous fluid disposed within the sealant.

13. The electronic device of claim 12, wherein the gear unit comprises:
a first guide threaded portion on the first shaft;
a second guide threaded portion on the second shaft; and
at least one gear wheel to engage with the first guide threaded portion and the second guide threaded portion to enable synchronous rotation between the first shaft and the second shaft in reverse directions.

14. The electronic device of claim 12, wherein the sealant comprises:
a pair of side walls; and
a pair of openings defined in each of the pair of side walls, wherein the pair of openings on each of the side walls are to receive a corresponding one of the first shaft and the second shaft.

15. The electronic device of claim 14, wherein the hinge assembly comprises:
a casing defining a pair of slots, wherein the pair of slots are aligned with the pair of openings such that the first and second shafts are received through respective one of the slots and the openings, and engaged with the first housing and the second housing to pivotably connect the first housing and the second housing.
